(19) United States
(12) Patent Application Publication
(10) Pub. No.: US 2004/0148496 A1
(43) Pub. Date: Jul. 29, 2004

(54) Method for handling a conditional move instruction in an out of order multi-issue processor

(76) Inventors: Chandra Mohan Reddy Thimmannagari, Fremont, CA (US); Yoganand Chillarige, Sunnyvale, CA (US); Sorin Lacobovici, San Jose, CA (US); Rabin A. Sugumar, Sunnyvale, CA (US); Robert Nuckolls, Sunnyvale, CA (US)

Correspondence Address: OSHA & MAY L.L.P./SUN, 1221 MCKINNEY, SUITE 2800, HOUSTON, TX, 77010, US

(21) Appl. No.: 10/351,902

(22) Filed: Jan. 27, 2003

(51) Int. Cl. G06F 9/00

(52) U.S. Cl. 712/226

(57) ABSTRACT

A method for handling a conditional move instruction using a two read port per issue slot register file, where the conditional move instruction references a first register, a second register, and a third register is provided. The method involves decoding a conditional move instruction, invoking at least two helper instructions dependent on the decoding, evaluating a register condition of the first register using a first helper instruction, and updating the third register with the contents of either the second register third register dependent on the evaluating using a second helper instruction.

### BACKGROUND OF INVENTION

A typical computer includes at least a microprocessor and some form of memory. The microprocessor has, among other components, arithmetic, logic, and control circuitry that interpret and execute instructions necessary for the operation and use of the computer system. FIG. 1 shows a block diagram of a typical computer system (10) having a microprocessor (12), memory (14), integrated circuits (IC) (16) that have various functionalities, and communication paths (18, 20), i.e., buses and wires, that are necessary for the transfer of data among the aforementioned components of the computer system (10).

An instruction executed by the typical computer shown in FIG. 1, at the lowest level, is represented by a series of ones and zeroes that describe physical operations. Assembly code is an abstraction of the series of ones and zeroes representing physical operations within the computer that allow humans to write instructions for the computer. Examples of instructions written in assembly code include ADD, SUB, MUL, DIV, BR, MOVr, etc. The examples of instructions previously mentioned are typically combined as an assembly program (or program) to accomplish sophisticated computer operations.

Depending on the type of instruction being executed, storage areas or registers are specified that contain data or a address to a location that contains data used in executing the instruction. Additional registers are used to facilitate the execution of instructions in a program, e.g., instruction registers, status registers, and the program counter.

Computer architects use a variety of techniques and implementations to increase the ability of the microprocessor to execute instructions and manage registers. In one implementation, a technique called pipelining is used in which multiple instructions overlap in execution to increase throughput, i.e., the number of instructions completed in a unit of time. Each step in the pipeline completes a part of an instruction and is referred to as a pipe stage or pipe segment.

Other implementations include the use of functional units in the microprocessor that manage particular sets of instructions of the program being executed. Examples of functional units include fetch units, execution units, decode units, branch units, etc. Microprocessors typically perform a fetch/execute cycle in which the instruction is read from memory (fetched) and executed in some manner, e.g., shifting bits to the left. The fetch unit may be designed to fetch more than one instruction at a time, and similarly, the execution unit may be designed to execute multiple instructions simultaneously. Other units may be used to manage the instructions.

Decode units are useful in identifying instructions that are conditionally executed. In certain situations, instructions with conditions, or conditional instructions, execute depending on an equivalence of two values. Examples of conditional instructions include branch instructions, conditional move instructions, etc. A “move on register” (MOVr) instruction is conditional instruction that moves the contents of registers depending on the register condition.

Examples of MOVr instructions include “move if register zero” instructions, “move if register greater than zero” instructions, “move if register less than zero” instructions, etc. Each of the previously mentioned MOVr types of instructions evaluates a different register condition. For example, the “move if register zero” (MOVrz) instruction is a conditional instruction that moves the contents of one register to another register, based on the evaluation of a register condition, i.e., if a register is equal to zero. The MOVrz instruction may be described by the following pseduocode, Code Sample 1.

Code Sample 1

| | |
|---|---|
| 1 | if (A == 0) |
| 2 | {S = T} |
| 3 | else |
| 4 | {noop} |

In Code Sample 1, values A, S, and T are located in registers R1, R3, and R2, respectively. In line 1, determining the equivalence of the contents of a register is often called a register condition. If the value in R1 (i.e., value A) is equal to zero, i.e., the register condition is met, and line 2 is performed. Accordingly, the contents in R2 are copied to R3. If the value in R1 is not equal to zero, the register condition is not met, and, according to line 4, no operation is executed. As can be deducted from code Sample 1, the MOVrz instruction for Code Sample 1 may be represented as MOVrz R1, R2, R3. Those skilled in the art will understand that using conditional move instructions transfers the dependence from the front of the pipeline (typical of branch instructions) to the end of the pipeline, when the register writes the contents of one register to another register.

In order to support the MOVr instruction in hardware, microprocessors typically use register files having three read ports, i.e., three read port per issue slot register files for a single issue microprocessor a three time “n” read port per issue slot register file for n-issue microprocessor (assuming a MOVR can be issued from any of the n-issue slots). Therefore, when a MOVr instruction is issued, the three read ports of register files dedicated to the issue slot from which the MOVR is issued read the contents of the three respective registers associated with the MOVr instruction, e.g., R1, R2, and R3. The execution unit evaluates the register condition and moves the contents of registers R2 into R3 conditionally. Other instructions are typically supported by registers having two read port per issue slot register files. The additional read port necessitated by the conditional move instructions has a substantial cost with regard to power and area consumption.

### SUMMARY OF INVENTION

In general, one aspect of the invention involves a method for handling a conditional move instruction using a two-read port per issue slot register file. The method further involves decoding a conditional move instruction, where the conditional move instruction references a first register, a second register, and a third register, invoking at least two helper instructions dependent on the decoding, evaluating a register condition of the first register using a first helper instruction, and updating the third register with the contents of the second register or third register dependent on the evaluating using a second helper instruction.

In general, one aspect of the invention includes an apparatus for handling a conditional move instruction with a two-read port per issue slot register file. The apparatus further includes a decode unit arranged to decode a conditional move instruction with a two-read port per issue slot register file, where the conditional move instruction references a first register, a second register, and a third register and arranged to invoke at least two helper instructions, and an execution unit arranged to evaluate a register condition of the first register dependent on a first helper instruction to produce a register evaluation and arranged to update the third register with the contents of the second register or third register based on the register evaluation using a second helper instruction.

In general, one aspect of the invention involves a method for handling a conditional move instruction using a two-read port per issue slot register file. The method further involves step for decoding a conditional move instruction using a two read port per issue slot register file, where the conditional move instruction references a first register, a second register, and a third register, step for invoking at least two helper instructions dependent on the step for decoding, step for evaluating a register condition of the first register using a first helper instruction, and step for updating the third register with the contents of the second register or third register dependent on the step for evaluating using a second helper instruction.

In general, one aspect of the invention includes an apparatus for handling a conditional move instruction with a two-read port per issue slot register file. The apparatus further includes means for decoding a conditional move instruction using a two-read port per issue slot register file, where the conditional move instruction references a first means for storing, a second means for storing, and a third means for storing, and for invoking at least two helper instructions, and means for evaluating a register condition of the first means for storing using a first helper instruction and for updating the third means for storing with the contents of the second means for storing or third means for storing based on a register evaluation using a second helper instruction.

Other aspects and advantages of the invention will be apparent from the following description and the appended claims.

### BRIEF DESCRIPTION OF DRAWINGS

FIG. 1 shows a block diagram of a typical computer.

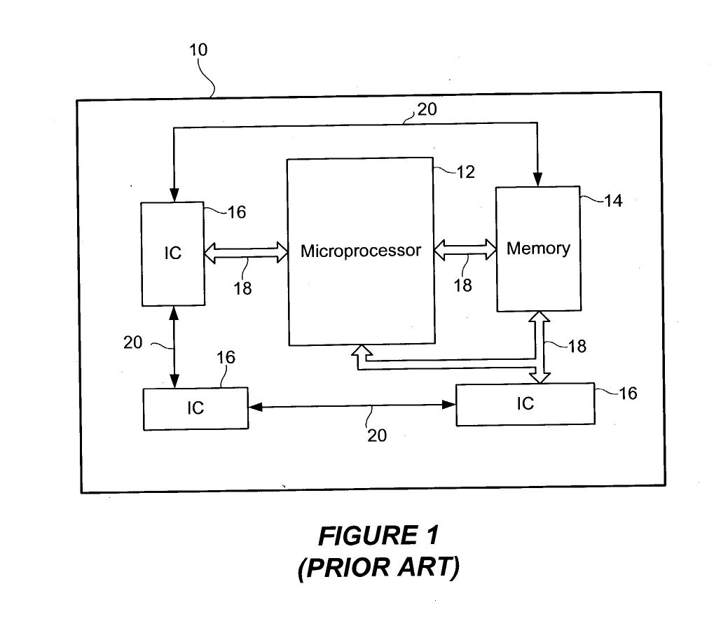

FIG. 2 shows a block diagram of a computer system in accordance with an embodiment of the present invention.

FIG. 3 shows a flow diagram for handling a conditional move instruction that is executable on a two read port per issue slot register file in accordance with an embodiment of the present invention.

FIG. 4 shows a block diagram of a temporary condition code register in accordance with an embodiment of the present invention.

FIG. 5 shows flow diagram for handling a move if register zero instruction that is executable on a two read port per issue slot register file in accordance with an embodiment of the present invention.

FIG. 6 shows a flow diagram for handling a move if register greater than zero instruction that is executable on a two read port per issue slot register file in accordance with an embodiment of the present invention.

FIG. 7 shows a block diagram of an exemplary rename and issue unit in accordance with one embodiment of the invention.

FIG. 8 shows a block diagram of an exemplary execution unit in accordance with one embodiment of the invention.

### DETAILED DESCRIPTION

Specific embodiments of the invention will now be described in detail with references to the accompanying figures. Like elements in various figures are denoted by like reference numerals throughout the figures for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

Embodiments of the invention relate to a method for handling conditional move instructions that are properly executable using a register file having two read ports, i.e., a two read port per issue slot register file. As previously mentioned, conditional move instructions (i.e., MOVr) typically require three read port per issue slot register files. In one or more embodiments, the present invention allows conditional move instructions to be properly executed using a two read port per issue slot register file by decoding the conditional move instruction and invoking a set of helper instructions based on the type of conditional move instruction.

The set of helper instructions evaluate a register condition of a conditional move instruction. In one or more embodiments, the evaluation of a conditional move instruction is stored in a sub-field of a renamed or architectural temporary condition code register. Based on a value in the sub-field, the contents of the registers of the conditional move instruction are displaced using the helper instructions. Accordingly, the evaluation of the register condition (previously requiring the three read port per issue slot register file) and the displacement of the register contents are handled by the set of helper instructions.

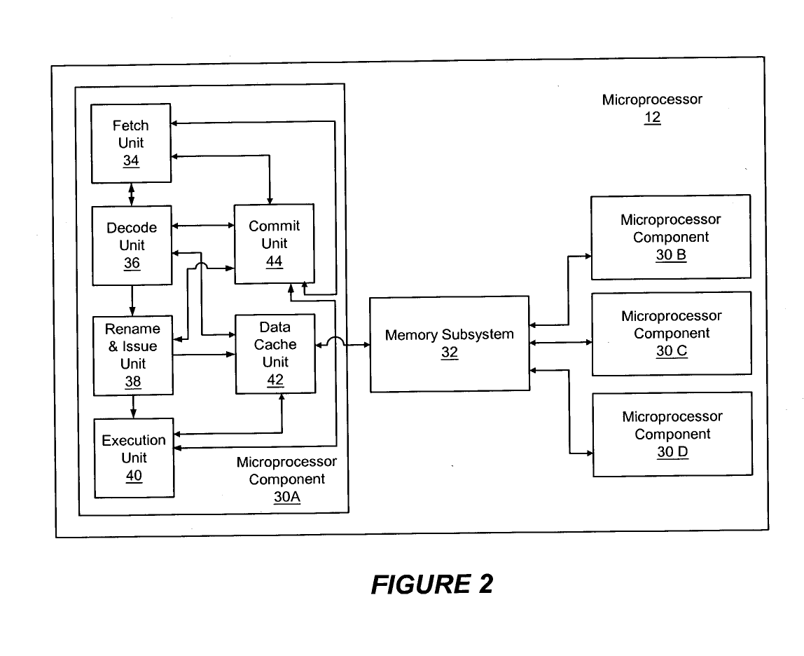

FIG. 2 shows a block diagram of a microprocessor in accordance with an embodiment of the present invention. The microprocessor (12) includes four microprocessor components (30A-30D). The microprocessor (30A) is in communication with the microprocessor components (30B-30D) through a memory subsystem (32) that provides memory operations for data that is not available in a cache memory (not shown) of the microprocessor (12). Each microprocessor component includes a fetch unit (34), a decode unit (36), a rename and issue unit (38), an execution unit (40), a data cache unit (42), and a commit unit (44).

The fetch unit (34) fetches a set of instructions (i.e., a fetch group) in any given cycle and forwards the fetch group to the decode unit (36). In one or more embodiments, a fetch group may include several instructions, e.g., zero to three per fetch group. The decode unit (36) decodes the instructions and forwards the instruction to the rename and issue unit (38), which, in turn, renames register fields along with checking for dependencies among the instructions. The issue queue (not shown) within the rename and issue unit (38) issues the instructions to the execution unit (40) which has corresponding issue slots to support the issued instructions. The execution unit (40) executes the instructions and writes the results, if required, into a working register file (WRF) (not shown). When the instruction finishes execution without exceptions, a commit unit (44) commits instructions, in some cases, writes the value in the WRF (not shown) to an architectural register file (ARF) (not shown). A data cache unit (42) handles all of the load and stores associated with executing the instruction.

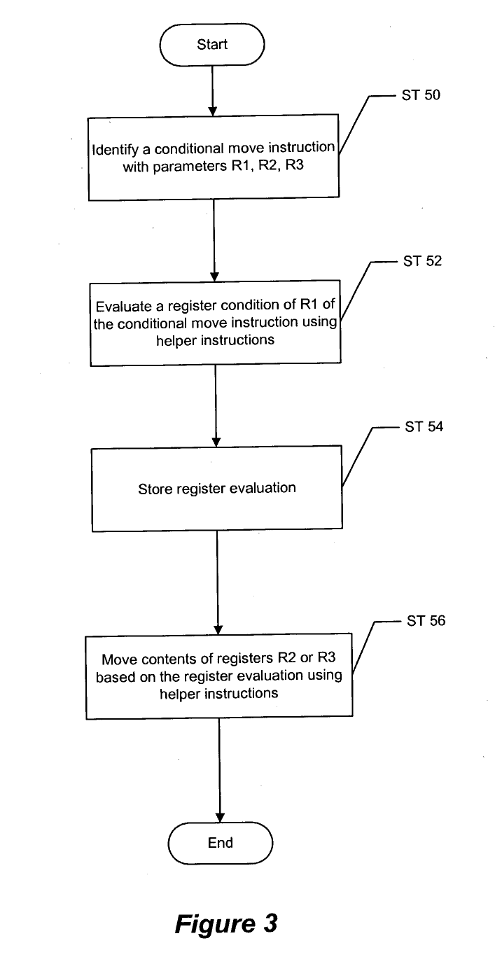

FIG. 3 shows an exemplary flow diagram for handling conditional move instructions executable on a two read port per issue slot register file in accordance with an embodiment of the present invention.

Initially, a conditional move instruction (i.e., MOVr) is identified (Step 50). In one embodiment, the conditional move instruction has parameters R1, R2, and R3 corresponding to three physical registers. Upon identification, helper instructions are invoked. Helper instructions are typically instructions that execute parts of an instruction, and when considered together, execute the original instruction. By invoking the helper instructions, a register condition of the conditional move instruction is evaluated (Step 52).

The register condition is evaluated, e.g., by subtracting the contents of R1. The result of the evaluation (register evaluation) is stored (Step 54). Depending on the register evaluation, contents of R2 or R3 are displaced (Step 56).

In one or more embodiments, a register evaluation is stored by writing to a temporary register, e.g., temporary condition code register (which may be renamed register in the CWRF or an architectural register in CARF). The temporary condition code register typically is used to store information about the last instruction that modifies the temporary condition code register. The present invention uses the register evaluation stored in the fields of the temporary condition code register to possibly move the contents of the registers. By using the information stored in the temporary condition code register, information regarding the register evaluation may be accessed by a two read port per issue slot register file (i.e., two read ports per issue slot, IWRF, or two read port per issue slot, IARF). The temporary condition code register maintains specific bits that identify various characteristics of a register evaluation, e.g., whether the register evaluation was equal or not equal.

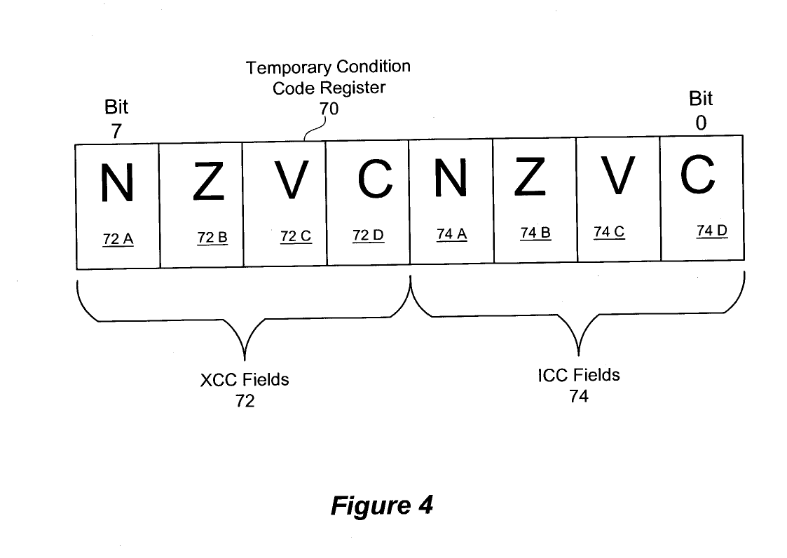

FIG. 4 shows a block diagram of an exemplary temporary condition code register in accordance with one or more embodiments of the present invention. The temporary condition code register (70) is an eight-bit register that includes two four-bit condition code fields. The four-bit condition code fields are named an XCC field (72) and an ICC field (74). Instructions that set the temporary code register (70) necessarily set both the XCC (72) field and the ICC (74) field. The XCC field (72) indicates the result (or register evaluation) from the arithmetic logic unit (ALU) of a sixty-four bit operation, whereas the ICC field (74) indicates the result from the ALU of a thirty-two bit operation.

Both the XCC field (72) and the ICC field (74) include four one-bit sub-fields, i.e., N (72A, 74A), Z (72B, 74B), V (72C, 74C), and C (72D, 74D), respectively. The fields indicate different characteristics of the last instruction that modified the temporary condition code register (as described below).

The N sub-field (72A, 74A) indicates whether a two's complement of a result from the ALU is negative. A logic 1 bit indicates negative two's complement result and a logic 0 indicates non-negative two's complement result. The Z sub-field (72B, 74B) indicates whether a result from the ALU is zero. A logic 1 bit indicates a zero result and a logic 0 indicates a non-zero result. The V sub-field (72C, 74C) indicates whether a result from the ALU produces an overflow. A logic 1 bit indicates an overflow and a logic 0 indicates no overflow. The C sub-field (72D, 74D) indicates whether a two's complement carry (or borrow) occurred. A logic 1 bit indicates a carry occurred and a logic 0 indicates no carry occurred.

Because the temporary condition code register (70) updates the XCC (72) and ICC (74) fields after an instruction executes, helper instructions can move contents of registers based on the values in the sub-fields (72A-72D, 74A-74D). Typically, determining and moving the contents of the register based on the register condition requires a three read port per issue slot register file, however a subtraction helper function along with a move register helper function eliminates such a requirement.

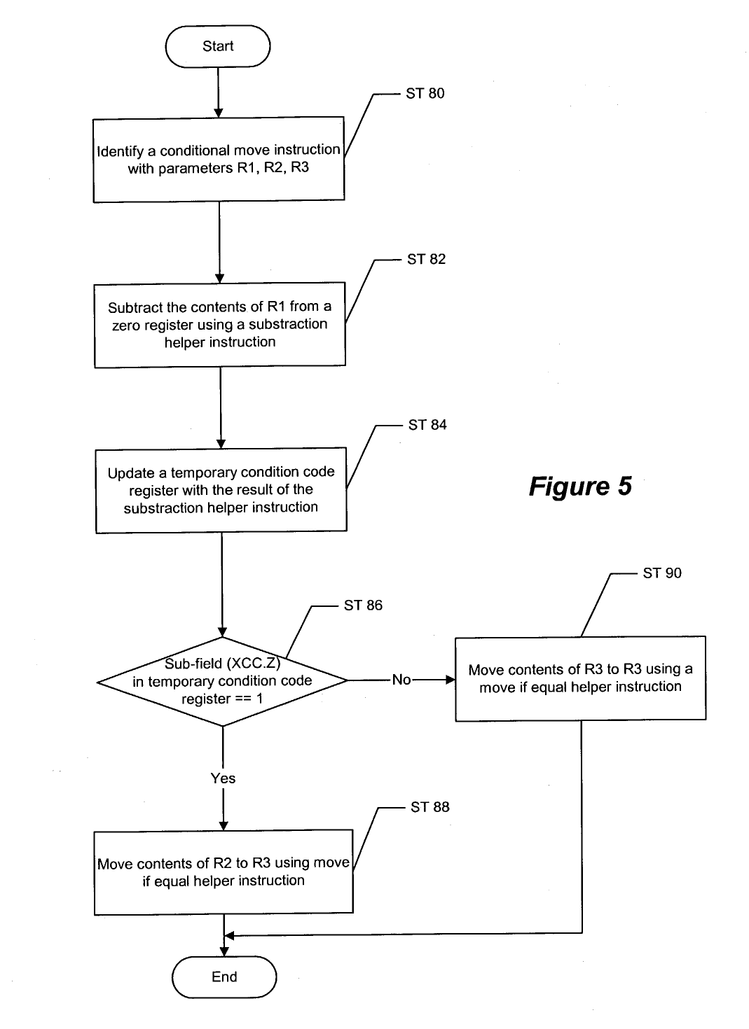

For example, FIG. 5 shows an exemplary flow diagram for handling a “move if register zero” instruction that is executable on a two read port per issue slot register file in accordance with one or more embodiments of the present invention.

Initially, a “move if register zero” (MOVrz) instruction is identified (Step 80). As shown in Code Sample 1, the MOVrz instruction involves evaluating whether the contents of R1 are equal to zero. To evaluate the register condition, a subtraction helper function is invoked that subtracts the contents of R1 from a zero register (Step 82). For example, a helper instruction, “H_SUBcc,” may be called, which resemembles the Sparc V9 SUBcc instruction developed by SPARC International Inc., Menlo Park, Calif.

The difference (or register evaluation) from the ALU of the subtraction helper instruction updates a temporary condition code register (Step 84). Assuming that the contents of R1 are zero, the sub-field Z (72B in FIG. 4) is updated with a logic 1.

A MOVr helper instruction is invoked that moves the contents of R2 or R3. For example, a helper instruction, “H_MOVE,” may be called, which resembles the Sparc™ V9 MOVE instruction. H_MOVE displaces the contents based on the value of the sub-field Z (72B). If the sub-field Z is valued at logic 1 (Step 86), the contents of R2 are moved to R3 using H_MOVE (Step 88). Otherwise, the contents of R3 are moved to R3 using H_MOVE (Step 90).

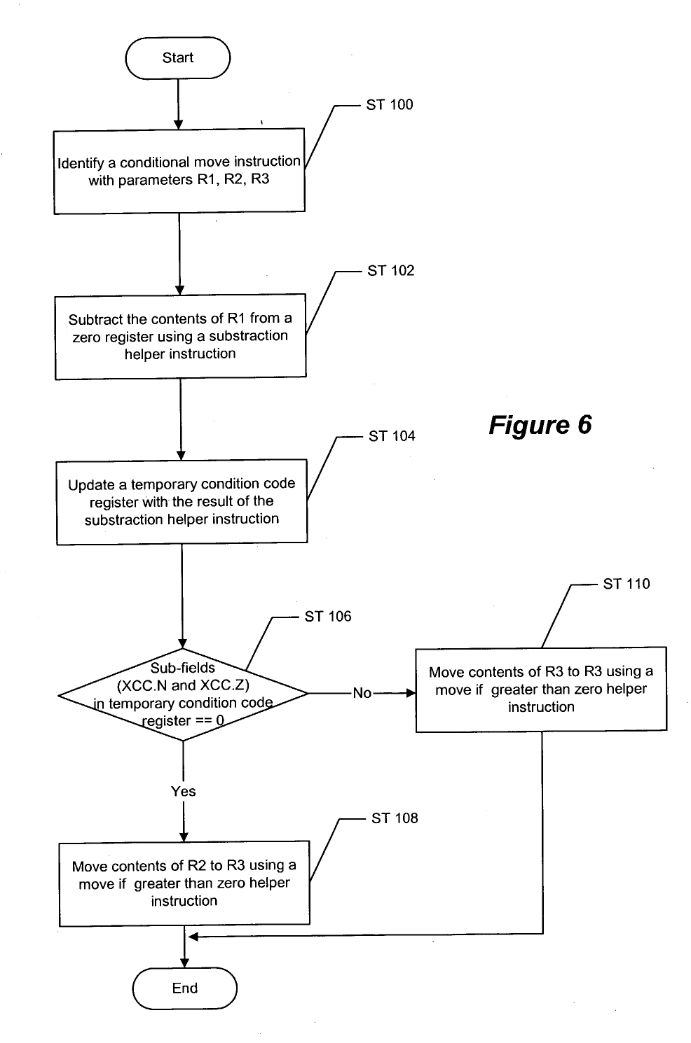

In another example, FIG. 6 shows an exemplary flow diagram for handling a move if register greater than zero instruction that is executable on a two read port per issue slot register file in accordance with one or more embodiments of the present invention.

Initially, a “move if register greater than zero” (MOVrgz) instruction is identified (Step 100). The MOVrgz instruction involves evaluating whether the contents of R1 are greater than zero. To evaluate the register condition, a subtraction helper function is invoked that subtracts the contents of R1 from a zero register (Step 102). For example, the helper instruction, H_SUBcc, may be called.

The difference (or register evaluation) from the ALU of the subtraction helper instruction updates a temporary condition code register (Step 104). Given the contents of R1 are greater than zero, the sub-fields Z (72B) and N (72A) are updated with a logic 0.

A MOVr helper instruction is invoked that moves the contents of R2 or R3. For example, a helper instruction, “H_MOVG,” may be called, which resembles the Sparc™ V9 MOVG instruction. H_MOVG displaces the contents based on the value of the sub-fields Z (72B) and N (72A). If the sub-fields Z (72B) and N 72A) are valued at logic 0 (Step 106), the contents of R2 are moved to R3 using H_MOVG (Step 108). Otherwise, the contents of R3 are moved to R3 using H_MOVG (Step 110). Because the sub-fields Z (72B) and N (72A) are at logic 0, the contents of R2 are moved to R3. If the contents of R1 had been zero or negative, the contents of R3 are moved to R3.

In one or more embodiments, the exemplary flow diagram shown in FIG. 5 for handling a “move if register zero” instruction that is executable on a two read port per issue slot register file may be implemented as follows. One skilled in the art can appreciate that the invention may be implemented in a variety of ways.

A fetch unit (34 in FIG. 2) in the microprocessor forwards the conditional move instruction in a bundle to a decode unit (36). An example of the bundle (or fetch group) is shown as Table 1. The first instruction is a conditional move instruction, ‘move if register equal to zero,’ that requires three-read port per issue slot register file. This instruction is valid as indicated by the logic 1 in the “valid” column of Table 1. The other instructions are invalid as indicated by the logic 0.

TABLE 1
Bundle Forwarded by Fetch Unit

| Instruction | Valid |
|---|---|
| MOVRZ R1, R2, R3 | 1 |
| — | 0 |
| — | 0 |

Because the conditional move instruction requires a three-read port per issue slot register file, the decode unit (36) invokes two helper instructions whenever the decode unit encounters a conditional move instruction thereby limiting the number of read ports for the register file (i.e., IWRF or IARF) to two per issue slot. Examples of the two helper instructions that are invoked are shown in Table 2.

TABLE 2
Bundle Forwarded by Decode Unit

| Instruction | src1_vld | src2_vld | dst_vld | ccsrc_vld | ccdst_vld | src1 | src2 | ccsrc | IWRF | IARF | CWRF | CARF |
|---|---|---|---|---|---|---|---|---|---|---|---|---|
| H_SUBcc | 1 | 1 | 0 | 0 | 1 | 50 | 0 | — | — | — | 22 | 7 |
| SUBcc | | | | | | | | | | | | |
| R1, g0, | | | | | | | | | | | | |
| g0 | | | | | | | | | | | | |
| H_MOVE | 1 | 1 | 1 | 1 | 0 | 51 | 52 | 7 | 23 | 52 | — | — |
| R2, R3, | | | | | | | | | | | | |
| R3 | | | | | | | | | | | | |
| — | — | — | — | — | — | — | — | — | — | — | — | — |

The first column shows the instructions invoked by the decode unit. The remaining columns provide information regarding registers to be read or to be written in accordance with the instruction. For example, the subtraction helper instruction in the second row reads from a valid source registers R1 and the global register, g0, (src1_vld and src2_vld indicate logic 1), however the subtraction helper instruction does not write to a valid destination register (dst_vld indicates logic 0, because the g0 is a read-only register). Additionally, the subtraction helper function does not read the contents of the temporary condition code register to fully execute (ccsrc_vld indicates logic 0). The subtraction helper instruction writes to the temporary condition code register (ccdst_vld indicates logic 1).

The physical register of R1 (src1) is register 50, and the physical register of g0 (src2) is register 0 (or the zero register). The result of the subtraction helper function is written to the condition code working register file (CWRF) in register 22. The register 22 is also known as renamed temporary condition code register. At the time of commit, the condition code architecture register file (CARF) is updated with the value stored in register 22 to register 7. Register 7 is also known as the architectural temporary condition code register or temporary condition code register.

Similar information is provided regarding the move helper instruction found in the third row. In particular, the physical register of R2 (src1) is register 51, and the physical register of R3 (src2) is register 52. The result of the move helper function is written to the integer working register file (IWRF) in register 23. At the time of commit, the integer architecture register file (IARF) is updated with the value stored in register 23 to register 52.

The bundle in Table 2 is forwarded to the rename and issue unit, where the physical source registers belonging to an instruction are renamed to working registers in the working register file. During execution, the renamed register in the working register files, i.e., the CWRF and the IWRF, are used while in the execution (i.e., it is assumed that instruction prior to this fetch group which resulted in updating R1, R2, and R3 have not been committed yet and helper instructions are committed only after both have finished execution. When, the instructions are fully executed and ready to commit, the appropriate registers in the architecture register files, i.e., CARF and the IARF, are updated.

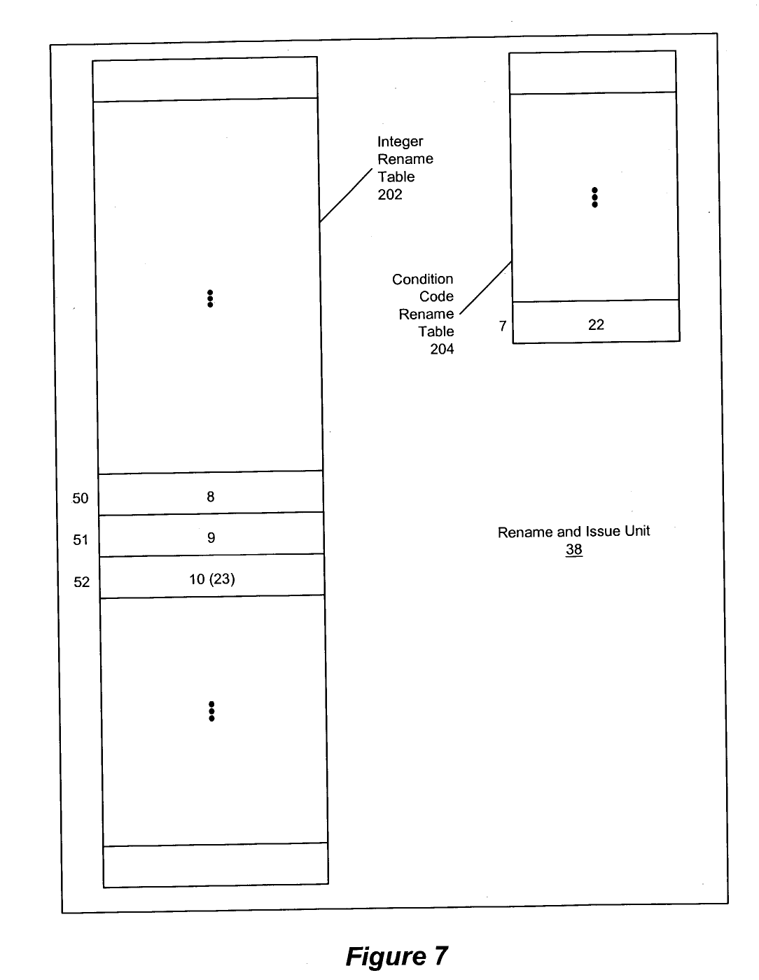

FIG. 7 shows a block diagram of an exemplary rename and issue unit in accordance with one embodiment of the invention. The rename and issue unit (38 as shown in FIG. 2) includes an integer rename table (202) and a condition code rename table (204). In the example, the integer rename table (202) renames source registers 50, 51, and 52 belonging to instructions, H_SUBcc and H_MOVE, to registers 8, 9, 10 in the IWRF. It also results in updating register 52 with a newly renamed value of 23 (i.e., IWRF value assigned by the decode unit to H_MOVE). Additionally, the condition code rename table updates register 7 (i.e., temporary condition code register) with newly renamed value of 22 (i.e., CWRF value assigned by the decode unit to H_SUBcc) and at the same time renames register 7 belonging to instruction H_MOVE to register 22 in the CWRF.

The instructions in the bundle shown in Table 2 in addition to the corresponding renamed registers are forwarded to the execution unit in two consecutive cycles. Accordingly, the execution unit executes the helper subtraction instruction and helper move instruction.

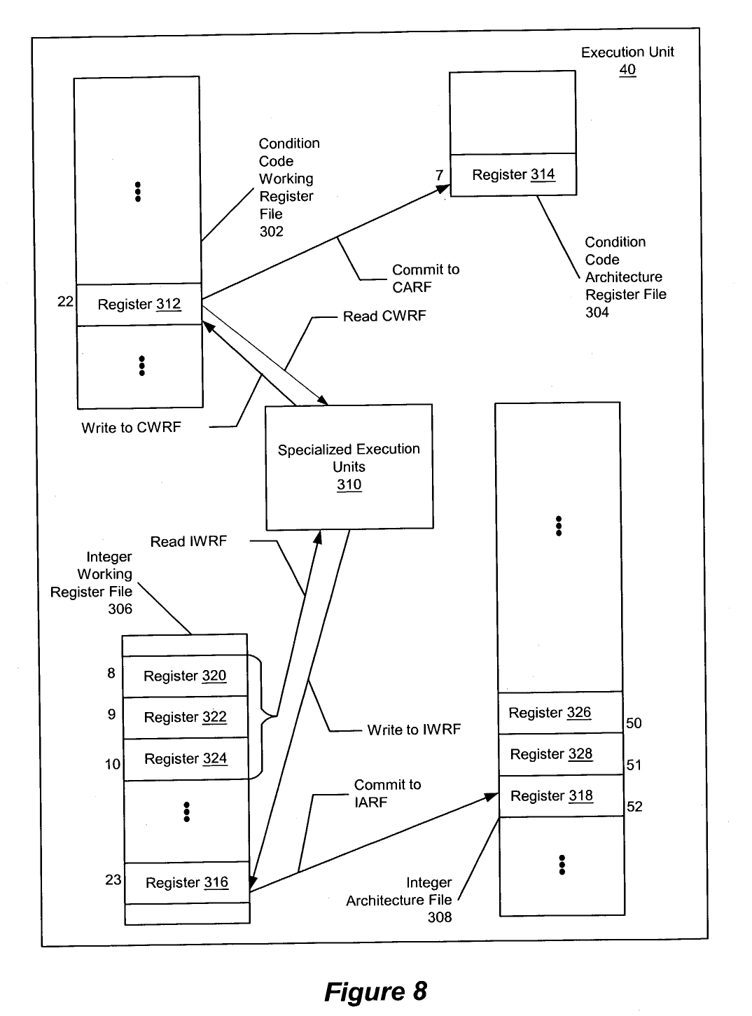

FIG. 8 shows a block diagram of an exemplary execution unit in accordance with one embodiment of the invention. The execution unit (40 as shown in FIG. 2) includes a CWRF (302), CARF (304), IARF (306), IWRF (308), and specialized execution units (310).

Continuing with the previous example, the registers R1, R2, and R3 in the MOVrz instruction are physical registers 50, 51, and 52 (326, 328, and 318) in the IARF (308). These physical registers (326, 328, and 318) correspond to registers in the IWRF (306) which are renamed as register 8, 9, and 10 (320, 322, and 324), as shown in FIG. 7 in the integer rename table. Additionally, the condition code rename table shows register 7 (i.e., temporary condition code register) in the CARF (304) corresponds to register 22 in CWRF (302).

Referring to FIG. 8, during execution, the subtraction helper function writes the result of subtracting the contents of R1 (renamed working register 8 (320)) from g0 to register 22 (312) in the CWRF (302).

Then the move helper function reads from registers 22 (312), 9 (322), and 10 (324) and writes the result into register 23 (316) in the IWRF (306). In other words, the sub-field Z (72B in FIG. 4) of the renamed temporary condition code register 22 (312) is read to determine if the sub-field is equal to 1. If the sub-field is equal to 1, then the contents of renamed working register 9 (322) (i.e., R2) are written to register 23 (316), otherwise the contents of renamed working register 10 (324) (i.e., R3) are written to register 23 (316). When the helper instructions have fully executed the result in register 23 (316) is committed to the IARF (308) in register 52 (318) and the result in register 22 (312) is committed to CARF (304) in register 7 (314), i.e., temporary condition code register.

In one or more embodiments, a conditional move instruction executable on a two read port per issue slot register file may be a ‘move if register equal to zero’ instruction, ‘move if register not equal to zero’ instruction, or ‘move if register less than zero’ instruction, etc.

In one or more embodiments, a conditional move instruction executable on a two read port per issue slot register file is identified in a decode unit of the microprocessor that invokes helper instructions, i.e., the decode unit forwards the helper instructions down the pipeline to execute the conditional move instruction. One skilled in the art can appreciate that a conditional instruction can be identified in many ways.

In one or more embodiments, helper instructions are implemented such that the helper instructions behave according to a corresponding instruction, e.g., a helper instruction that subtracts behaves as a typical subtraction instruction.

In one or more embodiments, a register condition of a conditional move instruction executable on a two-read port per issue slot register file is evaluated using a helper instruction. The helper instruction evaluates the register condition through arithmetic operations or logical operations. One skilled in the art can appreciate that a register condition of a conditional move instruction can be evaluated in many ways through various combinations of arithmetic and logical operations, such that the information stored in the renamed or architectural temporary condition code register indicates how contents of the registers are to be displaced.

Advantages of the present invention may include one or more of the following. In one or more embodiments, a conditional move instruction supported by a three read-port register may be adapted to execute properly on a two read port per issue slot register file. The use of a conditional move instruction typically requiring a three read port per issue slot register file no longer requires the third read port, thereby reducing power and area consumption.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
decoding a conditional move instruction using a two read port per issue slot register file, wherein the conditional move instruction references a first register, a second register, and a third register;
invoking at least two helper instructions dependent on the decoding;
evaluating a register condition of the first register using a first helper instruction; and
updating the third register dependent on the evaluating using a second helper instruction.

2. The method of claim 1, wherein the evaluating comprises performing arithmetic and logical operations on contents of the first register.

3. The method of claim 2, wherein the evaluating comprises subtracting the contents of the first register from a zero register.

4. The method of claim 1, wherein updating comprises transferring the contents of the second register to the third register dependent on the evaluating.

5. The method of claim 1, wherein the updating comprises transferring the contents of the third register to the third register dependent on the evaluating.

6. The method of claim 1, further comprising:
storing a characteristic of a register evaluation resulting from the evaluating in a sub-field of a temporary condition code register.

7. An apparatus, comprising:
a decode unit arranged to decode a conditional move instruction with a two-read port per issue slot register file, wherein the conditional move instruction references a first register, a second register, and a third register and arranged to invoke at least two helper instructions; and
an execution unit arranged to evaluate a register condition of the first register dependent on a first helper instruction to produce a register evaluation and arranged to update the second and third registers based on the register evaluation using a second helper instruction.

8. The apparatus of claim 7, wherein the execution unit comprises:
a working register file arranged to store contents of the first register, the second register, the third register, and the register evaluation; and
an architectural register file arranged store the contents of the working register file, wherein the architectural register file comprises a temporary condition code register arranged to store the register evaluation.

9. The apparatus of claim 8, wherein the temporary condition code register comprises a set of fields arranged to indicate a characteristic of the register evaluation.

10. The apparatus of claim 9, wherein the characteristic of the register evaluation indicates whether the register evaluation is negative or non-negative.

11. The apparatus of claim 9, wherein the characteristic of the register evaluation indicates whether the register evaluation is zero or non-zero.

12. A method, comprising:
step for decoding a conditional move instruction using a two read port per issue slot register file, wherein the conditional move instruction references a first register, a second register, and a third register;
step for invoking at least two helper instructions dependent on the step for decoding;
step for evaluating a register condition of the first register using a first helper instruction; and
step for updating the third register dependent on the step for evaluating using a second helper instruction.

13. The method of claim 12, wherein the step for evaluating comprises a step for performing arithmetic and logical operations on contents of the first register.

14. The method of claim 13, wherein the step for evaluating comprises a step for subtracting the contents of the first register from a zero register.

15. The method of claim 12, wherein the step for updating comprises a step for transferring the contents of the second register to the third register dependent on the step for evaluating.

16. The method of claim 12, wherein the step for updating comprises a step for transferring the contents of the third register to the third register dependent on the step for evaluating.

17. The method of claim 12, further comprising:
step for storing a characteristic of a register evaluation resulting from the step for evaluating in a sub-field of a temporary condition code register.

18. An apparatus, comprising:
means for decoding a conditional move instruction with a two-read port per issue slot register file, wherein the conditional move instruction references a first means for storing, a second means for storing, and a third means for storing, and for invoking at least two helper instructions; and
means for evaluating a register condition of the first means for storing using a first helper instruction to produce a register evaluation and for updating the second and third means for storing based on the register evaluation using a second helper instruction.

19. The apparatus of claim 18, wherein the execution unit comprises:
a working means for storing contents of the first storing means, the second storing means, the third storing means, and the register evaluation; and
an architectural means for storing the contents of the working register file, wherein the architectural means for storing comprises a temporary means for storing the register evaluation.

20. The apparatus of claim 19, wherein the temporary means for storing comprises a set of means for indicating a characteristic of the register evaluation.
